(19) United States
(12) Patent Application Publication
(10) Pub. No.: US 2021/0159501 A1
(43) Pub. Date: May 27, 2021

(54) LITHIUM ION SECONDARY BATTERY

(71) Applicant: MURATA MANUFACTURING CO., LTD., Kyoto (JP)

(72) Inventors: Yuichiro HASHIZUME, Kyoto (JP); Takeshi HAYASHI, Kyoto (JP)

(21) Appl. No.: 17/162,983

(22) Filed: Jan. 29, 2021

Related U.S. Application Data
(63) Continuation of application No. PCT/JP2019/029009, filed on Jul. 24, 2019.

(30) Foreign Application Priority Data
Jul. 30, 2018 (JP) 2018-142803

(51) Int. Cl. H01M 4/58; H01M 10/0525; H01M 10/0585; H01M 50/204; H01M 50/249; H01M 10/0567; H01M 4/62; H01M 4/587

(52) U.S. Cl. CPC H01M 4/5825; H01M 10/0525; H01M 10/0585; H01M 50/204; H01M 2004/021; H01M 10/0567; H01M 4/622; H01M 4/587; H01M 2220/20; H01M 50/249

(57) ABSTRACT

A lithium ion secondary battery includes a positive electrode, a negative electrode, a separator disposed between the positive electrode and the negative electrode, and a non-aqueous electrolyte. The positive electrode includes a positive electrode active material layer including a lithium iron phosphate. The positive electrode active material layer has a pore curvature from 50 to 120 as measured by a mercury porosimeter. The negative electrode includes a negative electrode active material layer including graphite. The negative electrode active material layer has a pore curvature from 5 to 30 as measured by the mercury porosimeter.

### CROSS REFERENCE TO RELATED APPLICATIONS

The present application is a continuation of PCT patent application no. PCT/JP2019/029009, filed on Jul. 24, 2019, which claims priority to Japanese patent application no. JP2018-142803 filed on Jul. 30, 2018, the entire contents of which are being incorporated herein by reference.

### BACKGROUND

The present technology generally relates to a lithium ion secondary battery.

Conventionally, secondary batteries have been used as power supplies for various electronic devices. The secondary battery has a structure in which a positive electrode, a negative electrode, a separator disposed between the positive electrode and the negative electrode, and an electrolyte are encapsulated in an exterior body. In particular, in a lithium ion secondary battery, lithium ions move between a positive electrode and a negative electrode to charge and discharge the battery with an electrolyte interposed therebetween.

### SUMMARY

The present technology generally relates to a lithium ion secondary battery.

The inventors have found that the following new problems occur in the conventional lithium ion secondary battery:

(1) When a lithium ion secondary battery is used in a low temperature (for example, −20° C.) environment, the resistance of the secondary battery increases, which causes deteriorated charge/discharge efficiency.

(2) The increase in resistance under a low-temperature environment is remarkable when charging and discharging are repeated under the low-temperature environment.

An object of the present technology is to provide a lithium ion secondary battery which can more sufficiently suppress an increase in resistance of a secondary battery in a low temperature (for example, −20° C.) environment.

Another object of the present technology is to provide a lithium ion secondary battery which can more sufficiently suppress an increase in resistance of the secondary battery in a low temperature (for example, −20° C.) environment even after repeated charging and discharging.

According to an embodiment of the present technology, a lithium ion secondary battery is provided. The lithium ion secondary battery includes a positive electrode; a negative electrode; a separator disposed between the positive electrode and the negative electrode; and a non-aqueous electrolyte. The positive electrode includes a positive electrode active material layer including a lithium iron phosphate. The positive electrode active material layer has a pore curvature from 50 to 120 as measured by a mercury porosimeter. The negative electrode includes a negative electrode active material layer including graphite. The negative electrode active material layer has a pore curvature from 5 to 30 as measured by the mercury porosimeter.

The lithium ion secondary battery of the present technology can more sufficiently suppress an increase in resistance of the secondary battery in a low temperature (for example, −20° C.) environment. The effect described in the present description is merely an example and is not restrictive, and an additional effect may be provided.

### BRIEF DESCRIPTION OF THE FIGURES

FIG. 1 is a graph showing a relationship between a pore curvature of each of a positive electrode active material layer and a negative electrode active material layer in a cell produced in Experimental Example 1 and an evaluation result of DCR at −20° C. according to an embodiment of the present technology.

### DETAILED DESCRIPTION

As described herein, the present disclosure will be described based on examples with reference to the drawings, but the present disclosure is not to be considered limited to the examples, and various numerical values and materials in the examples are considered by way of example. The present disclosure provides a lithium ion secondary battery. In the present specification, the term “lithium ion secondary battery” refers to a battery which can be repeatedly charged and discharged by the transfer of electrons accompanying lithium ions. Therefore, the “lithium ion secondary battery” is not excessively limited by its name, and may include, for example, “a lithium ion electric storage device” and the like. In the present specification, the “lithium ion secondary battery” may be simply referred to as a “secondary battery” or a “cell”. The “secondary battery” is not excessively limited by its name, and may include, for example, “an electric storage device” and the like.

The secondary battery of the present technology includes a positive electrode, a negative electrode, and a separator disposed between the positive electrode and the negative electrode, and further includes a non-aqueous electrolyte. The secondary battery of the present technology is usually configured by encapsulating an electrode assembly constituted of the positive electrode, the negative electrode, and the separator, and the non-aqueous electrolyte in an exterior body.

The positive electrode has at least a positive electrode active material layer. The positive electrode is usually configured by the positive electrode active material layer and a positive electrode current collector (foil), and the positive electrode active material layer is provided on at least one surface of the positive electrode current collector. For example, in the positive electrode, the positive electrode active material layer may be provided on each of both surfaces of the positive electrode current collector, or the positive electrode active material layer may be provided on one surface of the positive electrode current collector. A positive electrode which is preferable from the viewpoint of increasing the capacity of the secondary battery includes the positive electrode active material layer on each of both surfaces of the positive electrode current collector. The secondary battery usually includes a plurality of positive electrodes, and may include one or more positive electrodes in which the positive electrode active material layer is provided on each of both surfaces of the positive electrode current collector and one or more positive electrodes in which the positive electrode active material layer is provided on one surface of the positive electrode current collector.

The positive electrode active material layer has a pore curvature of 50 or more and 120 or less. The positive electrode active material layer has a pore curvature of preferably 55 or more and 110 or less, more preferably 60 or more and 100 or less, and still more preferably 80 or more and 93.5 or less (particularly 85 or more and 93.5 or less), from the viewpoints of further reduction of resistance under a low-temperature environment and further reduction of resistance under a low-temperature environment during repeated charging and discharging. The pore curvature of such a positive electrode active material layer is higher than that of a positive electrode active material layer in a conventional secondary battery. By using the positive electrode active material layer having an appropriately high pore curvature as described above in combination with the negative electrode active material layer having a pore curvature to be described later, the moving distance of the lithium ions can be more sufficiently shortened while an electron path can be effectively secured in the positive electrode active material layer of the secondary battery. As a result, even under a low-temperature environment, the increase in resistance in the secondary battery can be more sufficiently suppressed. If the pore curvature is too large, the moving distance of the lithium ions becomes significantly long, which causes the increase in resistance under a low-temperature environment. If the pore curvature is too small, voids in the positive electrode active material layer are excessively widened, which is apt to cut the electron path to cause the increase in resistance under a low-temperature environment. In the present technology, the resistance under a low-temperature environment may be a value (DCR) obtained by dividing an amount of voltage breakdown when discharged at a current value equivalent to 10 C at −20° C. by the current value.

The pore curvature is one parameter which indicates the degree of meandering of pores. A smaller pore curvature indicates that the pores are closer to a straight path. Meanwhile, a larger pore curvature indicates that the pores are more meandering.

In the present specification, as the pore curvature, a value measured by a measuring apparatus “Autopore IV 9500” (manufactured by Shimadzu Corporation) based on a mercury porosimeter is used.

The pore curvature can be controlled by adjusting the crushed state of an active material dispersed in an electrode forming slurry (that is, an electrode slurry) and a pressure by a roll press machine when the electrode is prepared.

For example, when the active material dispersed in the electrode slurry is subjected to a crushing treatment in advance, the pore curvature of the active material layer is larger as a crushing condition is severer.

For example, when the active material layer is dried, and then compacted, a higher pressure to be applied provides a larger pore curvature of the active material layer.

The positive electrode active material layer usually has a capacitance density of one surface of 0.25 mAh/cm² or more and 3.0 mAh/cm² or less. The positive electrode active material layer has a capacitance density of one surface of preferably 0.5 mAh/cm² or more and 2.5 mAh/cm² or less, more preferably 1.0 mAh/cm² or more and 2.5 mAh/cm² or less, and still more preferably 1.5 mAh/cm² or more and 2.0 mAh g/cm² or less from the viewpoints of further reduction of resistance under a low-temperature environment and further reduction of resistance under a low-temperature environment during repeated charging and discharging. The capacitance density (single surface) of such a positive electrode active material layer is smaller than that (single surface) of the positive electrode active material layer in the conventional secondary battery.

In the present specification, the capacitance density of the positive electrode active material layer is one characteristic value suggesting the amount of the positive electrode active material layer of the positive electrode (particularly, the positive electrode active material contained in the layer), and a value measured by a method to be described in detail later is used.

A value obtained by the following method is used for the “capacity density (one surface) of the positive electrode active material layer”. First, a positive electrode active material layer coated on one surface of an electrode having both surfaces each having the positive electrode active material layer coated thereon is peeled off with acetone to obtain a single-sided electrode. The single-sided electrode is punched into a circle having a diameter of 11 mm with a puncher. Using this circular electrode having a diameter of 11 mm, a coin cell having a counter electrode Li metal is prepared. There are performed 5 cycles of charging the prepared coin cell at 0.5 mA to an upper limit voltage of 3.8 V, holding a constant voltage of 3.8 V until the current converges to 0.01 mA, and discharging the coin cell at a constant current of 0.5 mA to a lower limit voltage of 2.5 V. A value obtained by standardizing a discharge capacity in the 5th cycle with the area of the circular electrode having a diameter of 11 mm is defined as “one-sided capacitance density”.

The positive electrode active material layer contains a positive electrode active material, and usually further contains a binder and a conductive auxiliary agent. The positive electrode active material is usually made of a granular material, and a binder is contained in the positive electrode active material layer in order to maintain a sufficient contact between grains and the shape of the grains. Furthermore, a conductive auxiliary agent is preferably contained in the positive electrode active material layer in order to facilitate transmission of electrons promoting the battery reaction.

The positive electrode active material is a substance directly involved in the transfer of electrons in the secondary battery and is a main substance of the positive electrode which is responsible for charging and discharging, namely a battery reaction. More specifically, ions are generated in the electrolyte by “the positive electrode active material contained in the positive electrode active material layer”, and the ions move between the positive electrode and the negative electrode and the electrons are transferred, whereby charging and discharging are performed. The positive electrode active material layer is particularly a layer which can insert and extract lithium ions. Lithium ions move between the positive electrode and the negative electrode, to charge and discharge the battery with the electrolyte interposed therebetween.

The positive electrode active material contains at least a lithium iron phosphate, and may further contain other positive electrode active materials.

The lithium iron phosphate is a compound represented by a chemical formula of LiFePO₄, and includes, for example, a lithium iron phosphate having defects, and a lithium iron phosphate doped with a dissimilar metal, in addition to such a compound. The lithium iron phosphate, which is preferable from the viewpoints of further reduction of resistance under a low-temperature environment and further reduction of resistance under a low-temperature environment during repeated charging and discharging, is a compound represented by the above chemical formula.

The lithium iron phosphate having defects is an active material having defects caused by intentionally missing some elements such as Li from the stoichiometric composition LiFePO₄ of the lithium iron phosphate, and examples thereof include Li₁₋ₓFePO₄, LiFe_{1-y}PO₄, and LiFePO_{4-z}.

The lithium iron phosphate doped with a dissimilar metal is a lithium phosphate obtained by doping a part of iron atoms of a lithium iron phosphate with other metal atoms. Examples of the other metal atoms (that is, doped metal atoms) include one or more metals selected from the group consisting of aluminum, magnesium, zirconium, nickel, manganese, and titanium. The doping amount is usually 0.001 to 10 parts by weight, and preferably 0.01 to 7 parts by weight with respect to 100 parts by weight of iron in the lithium iron phosphate. When the lithium iron phosphate contains two or more metals as other metal atoms (doped metal atoms), the doping amount of each metal may be within the above range.

The lithium iron phosphate usually has an average grain diameter D50 of 1 μm or more and 10 μm or less. The lithium iron phosphate has an average grain diameter D50 of preferably 1 μm or more and 5 μm or less, and more preferably 1 μm or more and 3 m or less from the viewpoints of further reduction of resistance under a low-temperature environment and further reduction of resistance under a low-temperature environment during repeated charging and discharging.

In the present specification, as the average grain diameter D50, a value measured by a laser diffraction particle size distribution analyzer (LA960, manufactured by Horiba, Ltd.) is used.

The lithium iron phosphate usually has a specific surface area of 0.1 m²/g or more and 100 m²/g or less. The lithium iron phosphate has a specific surface area of preferably 0.5 m²/g or more and 50 m²/g or less, and more preferably 5 m²/g or more and 20 m²/g or less from the viewpoints of further reduction of resistance under a low-temperature environment and further reduction of resistance under a low-temperature environment during repeated charging and discharging.

In the present specification, as the specific surface area, a value measured by a specific surface area measuring apparatus (Macsorb, manufactured by Mountech Co., Ltd.) is used.

The other positive electrode active material than the lithium iron phosphate, which may be contained in the positive electrode active material layer, is not particularly limited as long as it is a material contributing to insertion and extraction of lithium ions. For example, the positive electrode active material is preferably a lithium-containing composite oxide. The lithium-containing composite oxide is usually a lithium transition metal composite oxide. The transition metal may be any transition metal (transition element), and examples thereof include a first transition element, a second transition element, and a third transition element. A preferred transition metal is the first transition element.

From the viewpoints of further reduction of resistance under a low-temperature environment and further reduction of resistance under a low-temperature environment during repeated charging and discharging, the other positive electrode active material is preferably a lithium transition metal composite oxide containing lithium and at least one type of transition metal selected from the group consisting of scandium, titanium, vanadium, chromium, manganese, iron, cobalt, nickel, copper, and zinc (particularly the group consisting of cobalt, nickel, manganese, and iron). Specific examples of such a lithium transition metal composite oxide include lithium cobaltate, lithium nickelate, lithium manganate, and these transition metals having a part replaced with another metal (particularly those doped). Examples of the other metal (doped metal) include one or more metals selected from the group consisting of aluminum, magnesium, zirconium, nickel, manganese, and titanium.

The other positive electrode active material usually has an average grain diameter D50 of 5 μm or more and 30 μm or less. From the viewpoints of further reduction of resistance under a low-temperature environment and further reduction of resistance under a low-temperature environment during repeated charging and discharging, the other positive electrode active material has an average grain diameter D50 of preferably 10 μm or more and 25 μm or less, and more preferably 8 μm or more and 20 μm or less.

The other positive electrode active material usually has a specific surface area of 0.01 m²/g or more and 10 m²/g or less. From the viewpoints of further reduction of resistance under a low-temperature environment and further reduction of resistance under a low-temperature environment during repeated charging and discharging, the other positive electrode active material has a specific surface area of preferably 0.05 m²/g or more and 5 m²/g or less, and more preferably 0.1 m²/g or more and 1 m²/g or less.

The positive electrode active material such as the above-mentioned lithium iron phosphate and other positive electrode active material can also be obtained as a commercially available product, or can also be produced by a known method. For example, when the positive electrode active material is produced, a known method for producing an inorganic compound can be used. Specifically, the positive electrode active material can be produced by weighing a plurality of compounds as raw materials so as to have a desired composition ratio, mixing them uniformly, and fire. Examples of the raw material compound include a lithium-containing compound, a transition element-containing compound, a typical element-containing compound, and an anion-containing compound. As the lithium-containing compound, for example, lithium hydroxide, chloride, nitrate, carbonate, and the like can be used. As the transition element-containing compound, for example, transition element oxides, hydroxides, chlorides, nitrates, carbonates, sulfates, organic acid salts, and the like can be used. When a transition element is Co, Mn, and Fe, specific examples of the transition element-containing compound include manganese dioxide, γ-MnOOH, manganese carbonate, manganese nitrate, manganese hydroxide, Co₃O₄, CoO, Fe₂O₃, and Fe₃O₄. As the typical element-containing compound, for example, typical element oxides, hydroxides, chlorides, nitrates, carbonates, sulfates, organic acid salts, and the like can be used. As the anion-containing compound, when the anion is fluorine, for example, lithium fluoride and the like can be used. The fire temperature is usually 400° C. or higher and 1200° C. or lower. Fire may be performed in air, vacuum, an oxygen atmosphere, a hydrogen atmosphere, or an inert gas atmosphere such as nitrogen and a rare gas.

The content of the lithium iron phosphate is usually 80% by weight or more and 99% by weight or less, and preferably 90% by weight or more and 95% by weight or less, with respect to the total weight (solid content weight) of the positive electrode active material layer. The positive electrode active material layer may contain two or more types of lithium iron phosphates, and in that case, the total content thereof may be within the above range. When the positive electrode active material layer contains the other positive electrode active material, the content of the other positive electrode active material is usually 10% by weight or less, particularly 1% by weight or more and 10% by weight or less, and preferably 1% by weight or more and 5% by weight or less, with respect to the total weight (solid content weight) of the positive electrode active material layer.

The binder which can be contained in the positive electrode active material layer is not particularly limited. Examples of the binder of the positive electrode active material layer include at least one type selected from the group consisting of polyvinylidene fluoride (PVdF), a vinylidene fluoride-hexafluoropropylene copolymer, a vinylidene fluoride-tetrafluoroethylene copolymer, polytetrafluoroethylene, and the like. From the viewpoints of further reduction of resistance under a low-temperature environment and further reduction of resistance under a low-temperature environment during repeated charging and discharging, the binder of the positive electrode active material layer preferably contains polyvinylidene fluoride (PVdF).

The content of the binder of the positive electrode active material layer is usually 0.1% by weight or more and 5% by weight or less with respect to the total weight (solid content weight) of the positive electrode active material layer. From the viewpoints of further reduction of resistance under a low-temperature environment and further reduction of resistance under a low-temperature environment during repeated charging and discharging, the content of the binder is preferably 1% by weight or more and 5% by weight or less, and more preferably 2% by weight or more and 5% by weight or less. The positive electrode active material layer may contain two or more types of binders, and in that case, the total content thereof may be within the above range.

The conductive auxiliary agent which can be contained in the positive electrode active material layer is not particularly limited. Examples of the conductive auxiliary agent in the positive electrode active material layer include at least one type selected from the group consisting of carbon blacks such as thermal black, furnace black, channel black, ketjen black, and acetylene black; graphite; non-graphitizable carbon; easy-graphitizable carbon; carbon fibers such as carbon nanotube, and vapor-grown carbon fiber; metal powders made of copper, nickel, aluminum, silver, and the like; and polyphenylene derivatives and the like. From the viewpoints of further reduction of resistance under a low-temperature environment and further reduction of resistance under a low-temperature environment during repeated charging and discharging, the conductive auxiliary agent of the positive electrode active material layer preferably contains conductive carbon materials such as carbon black, graphite, non-graphitizable carbon, easy-graphitizable carbon, and carbon fibers, and particularly carbon black.

The average diameter of the conductive auxiliary agent (particularly carbon black) is usually 1 nm or more and 20 nm or less, and preferably 2 nm or more and 12 nm or less. The average diameter is an average value of any 100 conductive auxiliary agents.

The content of the conductive auxiliary agent in the positive electrode active material layer is usually 0.1% by weight or more and 5% by weight or less with respect to the total weight (solid content weight) of the positive electrode active material layer. From the viewpoints of further reduction of resistance under a low-temperature environment and further reduction of resistance under a low-temperature environment during repeated charging and discharging, the content of the conductive auxiliary agent is preferably 1% by weight or more and 5% by weight or less, and more preferably 2% by weight or more and 5% by weight or less. The positive electrode active material layer may contain two or more types of conductive auxiliary agents, and in that case, the total content thereof may be within the above range.

The positive electrode active material layer can be obtained by, for example, applying and drying a positive electrode slurry, obtained by dispersing a positive electrode active material, a binder to be added if desired, and a conductive auxiliary agent in a solvent, to a positive electrode current collector, and compacting the resulting product with a roll press or the like. At this time, it is preferable to crush and disperse the positive electrode active material in the solvent in advance from the viewpoint of controlling the pore curvature of the positive electrode active material layer. Specifically, the pore curvature can be controlled by adjusting a treatment condition during crushing and a pressure during compacting. For example, as a mixing device, Eco Mill (a bead mill, manufactured by Asada Iron Works, Co., Ltd. is used to mix and stir the positive electrode slurry at 1000 rpm for 120 minutes, and the positive electrode slurry is applied and dried at a coating amount (after drying) of 12.5 mg/cm², followed by pressing the coated product at a linear pressure of about 10000 N/cm by a roll heated to 100° C., thereby providing a pore curvature of about 93. At this time, if a rotation rate is slowed down, a mixing time is shortened, and/or a linear pressure is lowered, the pore curvature is lowered. Meanwhile, if the rotation rate is speeded up, the mixing time is lengthened, and/or the linear pressure is increased, the pore curvature is increased. The solvent of the positive electrode slurry is not particularly limited, and usually a solvent which can dissolve the binder is used. Examples of the solvent of the positive electrode slurry include organic solvents such as N-methylpyrrolidone, toluene, tetrahydrofuran, cyclohexane, and methyl ethyl ketone, and water. A coating amount of the positive electrode slurry on one surface (after drying) is usually 1 mg/cm² or more and 30 mg/cm² or less, and preferably 5 mg/cm- or more and 20 mg/cm² or less. In a preferred aspect, the positive electrode active material and the binder in the positive electrode active material layer correspond to a combination of lithium iron phosphate and polyvinylidene fluoride.

The positive electrode current collector used for the positive electrode is a member contributing to the collection and supply of electrons generated in the positive electrode active material by the battery reaction. Such a positive electrode current collector may be a sheet-like metal member and may be in a porous or perforated form. For example, the positive electrode current collector may be a metal foil, a punching metal, a net, an expanded metal, or the like. The positive electrode current collector used for the positive electrode is preferably made of a metal foil containing at least one type selected from the group consisting of aluminum, stainless steel, nickel, and the like, and may be, for example, an aluminum foil.

The negative electrode has at least a negative electrode active material layer. The negative electrode is usually configured by the negative electrode active material layer and the negative electrode current collector (foil), and the negative electrode active material layer is provided on at least one surface of the negative electrode current collector. For example, in the negative electrode, the negative electrode active material layer may be provided on each of both surfaces of the negative electrode current collector, or the negative electrode active material layer may be provided on one surface of the negative electrode current collector. A negative electrode which is preferable from the viewpoint of further increasing the capacity of the secondary battery has the negative electrode active material layer on each of both surfaces of the negative electrode current collector. The secondary battery usually includes a plurality of negative electrodes, and may include one or more negative electrodes in which the negative electrode active material layer is provided on each of both surfaces of the negative electrode current collector and one or more negative electrodes in which the negative electrode active material layer is provided on one surface of the negative electrode current collector.

The negative electrode active material layer has a pore curvature of 5 or more and 30 or less. From the viewpoints of further reduction of resistance under a low-temperature environment and further reduction of resistance under a low-temperature environment during repeated charging and discharging, the negative electrode active material layer has a pore curvature of preferably 6 or more and 28 or less, more preferably 6.5 or more and 25 or less, and still more preferably 6.5 or more and 20 or less (particularly 7 or more and 15 or less). When the negative electrode active material layer has such a pore curvature, the moving distance of the lithium ions can be more sufficiently shortened while an electron path can be effectively secured in the negative electrode active material layer of the secondary battery. As a result, even under a low-temperature environment, the increase in resistance in the secondary battery can be more sufficiently suppressed. If the pore curvature is too large, the moving distance of the lithium ions becomes significantly long, which causes the increase in resistance under a low-temperature environment. If the pore curvature is too small, voids in the negative electrode active material layer are excessively widened, which is apt to cut the electron path to cause the increase in resistance under a low-temperature environment.

The amount of the negative electrode active material layer (particularly the negative electrode active material contained in the layer) is usually set such that the potential of the negative electrode when the secondary battery is in a fully charged state is within a range to be described later based on lithium metal.

The potential of the negative electrode is usually 10 mV or more and 300 mV or less based on lithium metal when the secondary battery is in a fully charged state, and from the viewpoints of further reduction of resistance under a low-temperature environment and further reduction of resistance under a low-temperature environment during repeated charging and discharging, the potential of the negative electrode is preferably 30 mV or more and 250 mV or less, and more preferably 100 mV or more and 200 mV or less. The fact that the negative electrode potential in the fully charged state is 100 mV or more means that the negative electrode potential in a stable state is 100 mV or more even in any state of charge (SOC) of the secondary battery, that is, the first stage of the graphite negative electrode is not used. The first stage is a mixed state of two phases: a state (phase) where Li ions are inserted into each of graphene layers constituting graphite; and a state where Li ions are inserted into every two layers. If the negative electrode potential is 100 mV or more, the first stage is not used, whereby an increase in resistance can be avoided. If the negative electrode potential is 200 mV or more, the cell voltage drops, which causes deteriorated output characteristics. Therefore, the negative electrode potential is preferably 200 mV or less.

In the present specification, the potential of the negative electrode in the fully charged state is one characteristic value suggesting the amount of the negative electrode active material layer (particularly the negative electrode active material contained in the layer) in the negative electrode. As the potential of the negative electrode, a value measured by a method to be described in detail later is used.

The “fully charged state” means a state where the secondary battery is subjected to constant current charge at a current value (1 C) which can charge and discharge a rated capacity at 25° C. in 1 hour to an upper limit voltage of 3.8 V, and a constant voltage of 3.8 V is then held until a charging current converges to 0.02 C.

For the “potential of the negative electrode in the fully charged state”, a value obtained by the following method is used. First, a fully charged cell is disassembled to take out a negative electrode, and a negative electrode active material layer coated on one surface of the electrode having both surfaces each having the negative electrode active material layer is peeled off with acetone to obtain a single-sided electrode. The single-sided electrode is punched into a circle having a diameter of 11 mm with a puncher. Using this circular electrode having a diameter of 11 mm, a coin cell having a counter electrode Li metal is prepared. The battery voltage of the prepared coin cell is measured with a voltage tester, and the voltage value is defined as “the potential of the negative electrode in the fully charged state”.

The negative electrode active material layer contains a negative electrode active material, and usually further contains a binder and a conductive auxiliary agent, like the positive electrode active material layer. The negative electrode active material is usually made of a granular material, and a binder is contained in the negative electrode active material layer in order to maintain a sufficient contact between grains and the shape of the grains. Furthermore, a conductive auxiliary agent is preferably contained in the negative electrode active material layer in order to facilitate transmission of electrons promoting the battery reaction.

The negative electrode active material contained in the negative electrode active material layer is, like the positive electrode active material contained in the positive electrode active material layer, a substance directly involved in the transfer of electrons in the secondary battery and is a main substance of the negative electrode which is responsible for charging and discharging, namely a battery reaction. More specifically, ions are generated in the electrolyte by “the negative electrode active material contained in the negative electrode active material layer”, and the ions move between the positive electrode and the negative electrode and the electrons are transferred, whereby charging and discharging are performed. The negative electrode material layer is particularly a layer capable of inserting and extracting lithium ions.

The negative electrode active material contains at least graphite, and may further contain other negative electrode active materials.

The graphite may be any graphite, and examples thereof include natural graphite (for example, flake-shaped natural graphite), artificial graphite, MCMB (mesocarbon microbeads), non-graphitizable carbon, and easy-graphitizable carbon). From the viewpoints of further reduction of resistance under a low-temperature environment and further reduction of resistance under a low-temperature environment during repeated charging and discharging, the graphite is preferably natural graphite (particularly flake-shaped natural graphite), artificial graphite, or a mixture thereof, and more preferably a mixture of natural graphite (particularly flake-shaped natural graphite) and artificial graphite.

The graphite has an average grain diameter D50 of usually 0.1 μm or more and 20 μm or less, and has an average grain diameter D50 of preferably 0.5 μm or more and 15 μm or less, and more preferably 1 μm or more and 12 μm or less from the viewpoints of further reduction of resistance under a low-temperature environment and further reduction of resistance under a low-temperature environment during repeated charging and discharging.

The graphite has a specific surface area of usually 0.1 m²/g or more and 40 m²/g or less, and has a specific surface area of preferably 0.5 m²/g or more and 30 m²/g or less, and more preferably 1 m²/g or more and 25 m²/g or less from the viewpoints of further reduction of resistance under a low-temperature environment and further reduction of resistance under a low-temperature environment during repeated charging and discharging.

The other negative electrode active material than graphite which may be contained in the negative electrode active material layer is not particularly limited as long as it is a substance contributing to insertion and extraction of lithium ions, and, for example, carbon materials other than graphite, oxides, lithium alloys, silicon, silicon alloys, tin alloys, and the like are preferable.

Examples of the carbon materials other than graphite include hard carbon, soft carbon, and diamond-like carbon. Examples of the oxide of the negative electrode active material include at least one type selected from the group consisting of silicon oxide [SiOx (0.5≤x≤1.5)],

tin oxide, indium oxide, zinc oxide, lithium oxide, and the like. The lithium alloy of the negative electrode active material may be any metal as long as the metal can be alloyed with lithium, and the lithium alloy may be, for example a binary, ternary or higher alloy of a metal such as Al, Si, Pb, Sn, In, Bi, Ag, Ba, Ca, Hg, Pd, Pt, Te, Zn or La and lithium. It is preferable that such an oxide and lithium alloy be amorphous as their structural forms. This is because degradation due to nonuniformity such as grain boundaries or defects is less likely to be caused.

The average grain diameter D50 of the other negative electrode active material is usually 5 μm or more and 30 μm or less, and from the viewpoints of further reduction of resistance under a low-temperature environment and further reduction of resistance under a low-temperature environment during repeated charging and discharging, the average grain diameter D50 is preferably 10 μm or more and 25 μm or less, and more preferably 12 m or more and 20 μm or less.

The specific surface area of the other negative electrode active material is usually 0.1 m²/g or more and 10 m²/g or less, and from the viewpoints of further reduction of resistance under a low-temperature environment and further reduction of resistance under a low-temperature environment during repeated charging and discharging, the specific surface area of the other negative electrode active material is preferably 0.5 m²/g or more and 5 m²/g or less, and more preferably 1 m²/g or more and 5 m²/g or less.

The content of the graphite is usually 90% by weight or more and 99% by weight or less, and preferably 95% by weight or more and 99% by weight or less, with respect to the total weight (solid content weight) of the negative electrode active material layer. The negative electrode active material layer may contain two or more types of graphites, and in that case, the total content thereof may be within the above range. When the negative electrode active material layer contains the other negative electrode active material, the content of the other negative electrode active material is usually 10% by weight or less, particularly 1% by weight or more and 10% by weight or less, and preferably 1% by weight or more and 5% by weight or less, with respect to the total weight (solid content weight) of the negative electrode active material layer.

The binder which can be contained in the negative electrode active material layer is not particularly limited. Examples of the binder of the negative electrode active material layer include at least one type selected from the group consisting of styrene-butadiene rubber (SBR), polyacrylic acid, polyvinylidene fluoride (PVdF), a polyimide-based resin, a polyamideimide-based resin, and derivatives thereof. From the viewpoints of further reduction of resistance under a low-temperature environment and further reduction of resistance under a low-temperature environment during repeated charging and discharging, the binder of the negative electrode active material layer preferably contains styrene butadiene rubber.

The content of the binder of the negative electrode active material layer is usually 0.1% by weight or more and 5% by weight or less with respect to the total weight (solid content weight) of the negative electrode active material layer. From the viewpoints of further reduction of resistance under a low-temperature environment and further reduction of resistance under a low-temperature environment during repeated charging and discharging, the content of the binder of the negative electrode active material layer is preferably 0.5% by weight or more and 3% by weight or less, more preferably 0.5% by weight or more and 2.5% by weight or less, and still more preferably 1% by weight or more and 2.5% by weight or less. The negative electrode active material layer may contain two or more types of binders, and in that case, the total content thereof may be within the above range.

The conductive auxiliary agent which can be contained in the negative electrode active material layer is not particularly limited. Examples of the conductive auxiliary agent in the negative electrode active material layer include at least one type selected from the group consisting of carbon blacks such as thermal black, furnace black, channel black, ketjen black, and acetylene black, carbon fibers such as carbon nanotube and vapor-grown carbon fiber, metal powders such as copper, nickel, aluminum, and silver, and polyphenylene derivatives, and the like.

The content of the conductive auxiliary agent of the negative electrode active material layer is usually 5% by weight or less, for example, 0.1% by weight or more and 5% by weight or less, and preferably 0.5% by weight or more and 2% by weight or less, with respect to the total weight (solid content weight) of the negative electrode active material layer. The negative electrode active material layer may contain two or more types of conductive auxiliary agents, and in that case, the total content thereof may be within the above range. When graphite is used as a negative electrode active material, a conductive auxiliary agent is not usually used.

The negative electrode active material layer may contain a thickener. Examples of the thickener include carboxymethyl cellulose (CMC).

The content of the thickener of the negative electrode active material layer is usually 0.1% by weight or more and 5% by weight or less, preferably 0.5% by weight or more and 2% by weight, and more preferably 0.5% by weight or more and 1.5% by weight or less, with respect to the total weight (solid content weight) of the negative electrode active material layer. The negative electrode active material layer may contain two or more types of thickeners, and in that case, the total content thereof may be within the above range.

The negative electrode active material layer can be obtained by, for example, applying and drying a negative electrode slurry, obtained by dispersing a negative electrode active material, a binder to be added if desired, a conductive auxiliary agent and a thickener in a solvent, to a negative electrode current collector, and compacting (rolling) the resulting product with a roll press machine or the like. The solvent of the negative electrode slurry is not particularly limited, and examples thereof include the same solvent illustrated as the solvent of the positive electrode slurry. A coating amount of the negative electrode slurry on one surface (after drying) is usually 1 mg/cm² or more and 20 mg/cm² or less, and preferably 5 mg/cm² or more and 10 mg/cm² or less.

In a preferred embodiment of the negative electrode active material layer, the negative electrode active material layer further contains styrene-butadiene rubber, acrylic resin, or a derivative thereof as a binder, and carboxymethyl cellulose as a thickener; a content of the binder is 0.5% by weight or more and 2.5% by weight or less with respect to a total amount of the negative electrode active material layer; and a content of the thickener is 0.5% by weight or more and 1.5% by weight or less with respect to the total amount of the negative electrode active material layer.

Since the negative electrode active material layer of the present embodiment contains a predetermined binder and thickener in appropriately reduced amounts, the movement of Li ions is more smoothly provided without being hindered. Therefore, the resistance of the secondary battery is further reduced under a low-temperature environment, and the resistance of the secondary battery is further reduced even when charging and discharging are repeated under a low-temperature environment.

The negative electrode current collector used for the negative electrode is a member contributing to the collection and supply of electrons generated in the positive electrode active material by the battery reaction. Such a current collector may be a sheet-like metal member and may be in a porous or perforated form. For example, like the positive electrode current collector, the negative electrode current collector may be a metal foil, a punching metal, a net, an expanded metal, or the like. The negative electrode current collector used for the negative electrode is preferably made of a metal foil containing at least one type selected from the group consisting of copper, stainless steel, nickel, and the like, and may be, for example, a copper foil. In a preferred aspect, the negative electrode active material and the binder in the negative electrode active material layer correspond to a combination of artificial graphite, natural graphite, and styrene-butadiene rubber.

The separator is not particularly limited as long as it can pass ions while preventing electrical contact between the positive electrode and the negative electrode. The material constituting the separator is not particularly limited as long as the electrical contact between the positive electrode and the negative electrode can be prevented, and examples thereof include an electrically insulating polymer. Examples of the electrically insulating polymer include polyolefin, polyester, polyimide, polyamide, and polyamideimide. Preferably, the separator is a porous or microporous insulating member and has a film form due to its small thickness. Although it is merely an example, a microporous membrane made of polyolefin may be used as the separator. In this respect, the microporous membrane used as the separator preferably contains, for example, only polyethylene (PE) or only polypropylene (PP) as polyolefin. Furthermore, the separator is more preferably a stacked body composed of “a microporous membrane made of PE” and “a microporous membrane made of PP”. The surface of the separator may be covered with an inorganic grain coating layer and/or an adhesive layer and the like. The surface of the separator may have adhesiveness.

The non-aqueous electrolyte assists movement of lithium ions released from the electrodes (positive electrode/negative electrode). The non-aqueous electrolyte contains a non-aqueous solvent and an electrolyte salt. The non-aqueous electrolyte may have a form such as liquid or gel. From the viewpoints of further reduction of resistance under a low-temperature environment and further reduction of resistance under a low-temperature environment during repeated charging and discharging, the non-aqueous electrolyte preferably has a liquid form. In the present specification, the term “liquid” non-aqueous electrolyte is also referred to as “non-aqueous electrolyte liquid”).

The non-aqueous solvent of the non-aqueous electrolyte is not particularly limited, and examples thereof include at least one type selected from the group consisting of carbonate-based solvents, ester-based solvents, sultone-based solvents, nitrile-based solvents, and fluorides thereof. From the viewpoints of further reduction of resistance under a low-temperature environment and further reduction of resistance under a low-temperature environment during repeated charging and discharging, the non-aqueous electrolyte preferably contains a carbonate-based solvent as a non-aqueous solvent.

The carbonate-based solvent contains cyclic carbonates and/or chain carbonates, and from the viewpoints of further reduction of resistance under a low-temperature environment and further reduction of resistance under a low-temperature environment during repeated charging and discharging, the carbonate-based solvent preferably contains cyclic carbonates and chain carbonates. Examples of the cyclic carbonates include at least one type selected from the group consisting of propylene carbonate (PC), ethylene carbonate (EC), fluoroethylene carbonate (FEC), butylene carbonate (BC), and vinylene carbonate (VC). Examples of the chain carbonates include at least one type selected from the group consisting of dimethyl carbonate (DMC), diethyl carbonate (DEC), ethyl methyl carbonate (EMC), and dipropyl carbonate (DPC). The content of the carbonate-based solvent is usually 10% by volume or more with respect to the non-aqueous solvent of the non-aqueous electrolyte, and from the viewpoints of further reduction of resistance under a low-temperature environment and further reduction of resistance under a low-temperature environment during repeated charging and discharging, the content of the carbonate-based solvent is preferably 50% by volume or more, and more preferably 90% by volume or more. The upper limit of the content of the carbonate-based solvent with respect to the non-aqueous solvent of the non-aqueous electrolyte is usually 100% by volume.

When the non-aqueous solvent contains cyclic carbonates and chain carbonates, the volume ratio of the cyclic carbonates to the chain carbonates (cyclic carbonates/chain carbonates) is usually 1/9 to 9/1, and from the viewpoints of further reduction of resistance under a low-temperature environment and further reduction of resistance under a low-temperature environment during repeated charging and discharging, the volume ratio of the cyclic carbonates to the chain carbonates is preferably 1/9 to 7/3, more preferably 1/9 to 6/4, still more preferably 1/9 to 4/6, and yet still more preferably 2/8 to 3/7.

Examples of the ester-based solvent include at least one type selected from the group consisting of methyl formate, ethyl formate, propyl formate, methyl acetate, ethyl acetate, propyl acetate, methyl propionate, ethyl propionate, propyl propionate (PP), and methyl butyrate. The content of the ester-based solvent is usually 50% by volume or less with respect to the non-aqueous solvent of the non-aqueous electrolyte, and from the viewpoints of further reduction of resistance under a low-temperature environment and further reduction of resistance under a low-temperature environment during repeated charging and discharging, the content of the ester-based solvent is preferably 30% by volume or less, and more preferably 10% by volume or less.

Examples of the sultone-based solvent include at least one type selected from the group consisting of propane sultone (PS) and propene sultone. The content of the sultone-based solvent is usually 50% by volume or less with respect to the non-aqueous solvent of the non-aqueous electrolyte, and from the viewpoints of further reduction of resistance under a low-temperature environment and further reduction of resistance under a low-temperature environment during repeated charging and discharging, the content of the sultone-based solvent is preferably 30% by volume or less, and more preferably 10% by volume or less.

Examples of the nitrile-based solvent include at least one type selected from the group consisting of adiponitrile (ADN), succinonitrile, suberonitrile, acetonitrile, glutaronitrile, methoxyacetonitrile, and 3-methoxypropionitrile. The content of the nitrile-based solvent is usually 10% by volume or less with respect to the non-aqueous solvent of the non-aqueous electrolyte, and from the viewpoints of further reduction of resistance under a low-temperature environment and further reduction of resistance under a low-temperature environment during repeated charging and discharging, the content of the nitrile-based solvent is preferably 5% by volume or less, and more preferably 1% by volume or less.

As the electrolyte salt of the non-aqueous electrolyte, for example, Li salts such as LiPF₆, LiBF₄, LiClO₄, LiCF₃SO₃, Li(CF₃SO₂)₂N, Li(C₂F₅SO₂)₂N, Li(CF₃)₂N, and LiB(CN)₄ are preferably used.

The concentration of the electrolyte salt in the non-aqueous electrolyte is not particularly limited, and may be, for example, 0.1 to 10 mol/L. From the viewpoints of further reduction of resistance under a low-temperature environment and further reduction of resistance under a low-temperature environment during repeated charging and discharging, the concentration of the electrolyte salt in the non-aqueous electrolyte is preferably 0.5 to 2 mol/L.

The non-aqueous electrolyte preferably contains a cyclic sulfate ester compound. This is because the resistance of the secondary battery is further reduced under a low-temperature environment even when charging and discharging are repeated. The details of the mechanism by which the inclusion of the cyclic sulfate ester compound in the non-aqueous electrolyte causes further reduced resistance of the secondary battery under a low-temperature environment even when charging and discharging are repeated are not clear, but this is considered to be based on the following mechanism. The cyclic sulfate ester compound is reduced and decomposed by initial charge and discharge performed before the shipment of the secondary battery to form a coat on the surface of the negative electrode. It is considered that the coat obtained by using the cyclic sulfate ester compound is thinner and more uniform, whereby the resistance of the secondary battery is further reduced under a low-temperature environment, and the resistance of the secondary battery is further reduced under a low-temperature environment even if charging and discharging are repeated.

The cyclic sulfate ester compound is an organic compound containing one or more cyclic sulfate ester skeletons such as a dioxathiolane skeleton and a dioxatian skeleton in one molecule, particularly one to three cyclic sulfate ester skeletons, and preferably two cyclic sulfate ester skeletons. From the viewpoints of further reduction of resistance under a low-temperature environment and further reduction of resistance under a low-temperature environment during repeated charging and discharging, the cyclic sulfate ester compound is preferably an organic compound containing one or two dioxathiolane skeletons in one molecule.

The cyclic sulfate ester compound usually has a molecular weight of 124 to 800, and from the viewpoints of further reduction of resistance under a low-temperature environment and further reduction of resistance under a low-temperature environment during repeated charging and discharging, the cyclic sulfate ester compound has a molecular weight of preferably 124 to 600, and more preferably 124 to 400.

Preferred Examples of the Cyclic Sulfate Ester Compound

include a cyclic sulfate ester compound represented by General Formula (I) below.

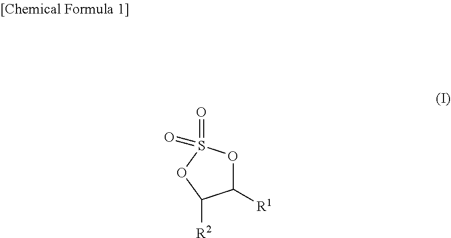

In General Formula (I), R¹ and R² each independently represent a hydrogen atom, an alkyl group having 1 to 6 carbon atoms, a phenyl group, a group represented by General Formula (II), or a group represented by General Formula (III), or R¹ and R² taken together represent a group which forms a benzene ring or a cyclohexyl ring together with a carbon atom bound to R¹ and a carbon atom bound to R².

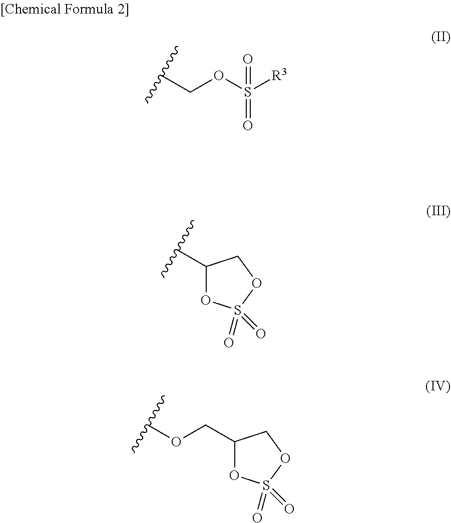

In General Formula (II), R³ represents a halogen atom, an alkyl group having 1 to 6 carbon atoms, a halogenated alkyl group having 1 to 6 carbon atoms, an alkoxy group having 1 to 6 carbon atoms, or a group represented by Formula (IV). Each wavy line in General Formula (II), General Formula (III), and General Formula (IV) represents a bonding position.

When the cyclic sulfate ester compound represented by General Formula (I) contains two groups represented by General Formula (II), the two groups represented by General Formula (II) may be the same as or different from each other.

In General Formula (II), specific examples of the “halogen atom” include a fluorine atom, a chlorine atom, a bromine atom, and an iodine atom. The halogen atom is preferably a fluorine atom.

In General Formulae (I) and (II), the “alkyl group having 1 to 6 carbon atoms” refers to a straight or branched alkyl group having carbon atoms of 1 or more and 6 or less, and specific examples thereof include a methyl group, an ethyl group, a propyl group, an isopropyl group, a butyl group, an isobutyl group, a sec-butyl group, a tert-butyl group, a pentyl group, a 2-methylbutyl group, a 1-methylpentyl group, a neopentyl group, a 1-ethylpropyl group, a hexyl group, and a 3,3-dimethylbutyl group. The alkyl group having 1 to 6 carbon atoms is more preferably an alkyl group having 1 to 3 carbon atoms.

In General Formula (II), the “halogenated alkyl group having 1 to 6 carbon atoms” refers to a straight or branched halogenated alkyl group having 1 to 6 carbon atoms, and specific examples thereof include a fluoromethyl group, a difluoromethyl group, a trifluoromethyl group, a 2,2,2-trifluoroethyl group, a perfluoroethyl group, a perfluoropropyl group, a perfluorobutyl group, a perfluoropentyl group, a perfluorohexyl group, a perfluoroisopropyl group, a perfluoroisobutyl group, a chloromethyl group, a chloroethyl group, a chloropropyl group, a bromomethyl group, a bromoethyl group, a bromopropyl group, an iodomethyl group, an iodoethyl group, and an iodopropyl group. The halogenated alkyl group having 1 to 6 carbon atoms is more preferably a halogenated alkyl group having 1 to 3 carbon atoms.

In General Formula (II), the “alkoxy group having 1 to 6 carbon atoms” refers to a straight or branched alkoxy group having 1 or more to 6 or less carbon atoms, and specific examples thereof include a methoxy group, an ethoxy group, a propoxy group, an isopropoxy group, a butoxy group, an isobutoxy group, a sec-butoxy group, a tert-butoxy group, a pentyloxy group, a 2-methylbutoxy group, a 1-methylpentyloxy group, a neopentyloxy group, a 1-ethylpropoxy group, a hexyloxy group, and a 3,3-dimethylbutoxy group. The alkoxy group having 1 to 6 carbon atoms is more preferably an alkoxy group having 1 to 3 carbon atoms.

In a preferred cyclic sulfate ester compound, in General Formula (I), R¹ and R² each independently represent a hydrogen atom, an alkyl group having 1 to 3 carbon atoms, or a group

represented by Formula (III). At this time, it is preferable that one group of R¹ or R² be a group represented by Formula (III) and the other group be a hydrogen atom or an alkyl group having 1 to 3 carbon atoms.

In a more preferable cyclic sulfate ester compound, in General Formula (I), R¹ and R² each independently represent a hydrogen atom or a group represented by Formula (III). At this time, it is preferable that one group of R¹ or R² be a group represented by Formula (III) and the other group be a hydrogen atom or a group represented by Formula (III).

Specific examples of the preferred cyclic sulfate ester compound include the following compounds:
compound 1 (in General Formula (I), R¹=R²=H),
compound 2 (in General Formula (I), R¹=Me and R²=H);
compound 3 (in General Formula (I), R¹=Et and R²=H);
compound 4 (in General Formula (I), R¹=Pr and R²=H);
compound 5 (in General Formula (1), R¹=H and R²=group represented by Formula (III));
compound 6 (in General Formula (I), R¹=Me and R²=group represented by Formula (III));
compound 7 (in General Formula (I), R¹=Et and R²=group represented by Formula (III));
compound 8 (in General Formula (I), R¹=Pr and R²=group represented by Formula (III)); and
compound 9 (in General Formula (I), R¹=R²=group represented by Formula (III)). H is a hydrogen atom; Me is a methyl group; Et is an ethyl group; and Pr is a propyl group.

The cyclic sulfate ester compound can be produced by a known method, or can be obtained as a commercially available product.

Examples of the commercially available product of the cyclic sulfate ester compound include 4,4′-bis(2,2-dioxo-1,3,2-dioxathiolane) (compound 5, manufactured by Tokyo Chemical Industry Co., Ltd.).

The cyclic sulfate ester compound can be produced, for example, by a method described in Paragraphs 0062 to 0068 of WO 2012/053644 and a method described in Tetrahedron Letters, 2000, vol. 41, p. 5053-5056.

From the viewpoints of further reduction of resistance under a low-temperature environment and further reduction of resistance under a low-temperature environment during repeated charging and discharging, the content of the cyclic sulfate ester compound is preferably 0.2% by weight or more and 5.0% by weight or less, more preferably 0.8% by weight or more and 4.0% by weight or less, still more preferably 1.2% by weight or more and 2.3% by weight or less, and most preferably 1.8% by weight or more and 2.2% by weight or less, with respect to the total weight of the non-aqueous electrolyte. The non-aqueous electrolyte may contain two or more types of cyclic sulfate ester compounds, and in that case, the total content thereof may be within the above range.

The secondary battery can be produced by encapsulating an electrode assembly including a positive electrode, a negative electrode, and a separator, and a non-aqueous electrolyte in an exterior body. In the electrode assembly, the positive electrodes and the negative electrodes are alternately disposed with the separator interposed therebetween.

The structure of the secondary battery is not particularly limited. For example, the secondary battery may have a stacked structure (planar stacked structure), a wound structure (jelly-roll structure), or a stack and folding structure. The phrase “the secondary battery may have a stacked structure (planar stacked structure), a wound structure (jelly-roll structure), or a stack-and-folding structure” means that the electrode assembly may have these structures. Specifically, for example, the electrode assembly may have a planar stacked structure obtained by stacking a plurality of electrode units (electrode configuration layer) including a positive electrode, a negative electrode, and a separator disposed between the positive electrode and the negative electrode in a planar form. For example, an electrode assembly may have a wound structure (jelly-roll type) obtained by winding an electrode unit (electrode configuration layer) including a positive electrode, a negative electrode, and a separator disposed between the positive electrode and the negative electrode in a roll form. For example, the electrode assembly may have a so-called stack and folding type structure in which a positive electrode, a separator, and a negative electrode are stacked on a long film, and then folded. The secondary battery of the present technology preferably has a stacked structure. This is because, by providing the secondary battery having a stacked structure, the electronic resistance of the secondary battery is made smaller than that of other structures, which provides further reduction of the resistance of the secondary battery under a low-temperature environment and further reduction of the resistance of the secondary battery under a low-temperature environment even when charging and discharging are repeated.

The exterior body may be a flexible pouch (soft bag) or a hard case (hard housing).

When the exterior body is a flexible pouch, the flexible pouch is usually formed from a laminate film, and sealing is achieved by heat-sealing a periphery part. As the laminate film, a film obtained by stacking a metal foil and a polymer film is generally used. Specific examples thereof include one having a three-layer structure including an outer layer polymer film, a metal foil, and an inner layer polymer film. The outer layer polymer film prevents permeation of moisture and the like and damage of the metal foil due to contact and the like, and polymers such as polyamide and polyester can be suitably used. The metal foil prevents permeation of moisture and gas, and foils made of copper, aluminum, stainless steel, and the like can be suitably used. The inner layer polymer film protects the metal foil from the electrolyte stored therein, and is used for melting and sealing during heat sealing. Polyolefin or acid-modified polyolefin can be suitably used. The thickness of the laminate film is not particularly limited, and is preferably, for example, 1 μm or more and 1 mm or less.

When the exterior body is a hard case, the hard case is usually formed from a metal plate, and sealing is achieved by irradiating a periphery part with laser. As the metal plate, a metal material made of aluminum, nickel, iron, copper, stainless steel, or the like is generally used. The thickness of the metal plate is not particularly limited, and is preferably, for example, 1 μm or more and 1 mm or less.

The secondary battery usually has two external terminals. The two external terminals are connected to an electrode (positive electrode or negative electrode) with a current collecting lead interposed therebetween. As a result, the two external terminals are led out from the exterior body.

The present technology can provide a lithium ion secondary battery pack configured by connecting two or more, preferably four or more (for example, four) secondary batteries in series as described above. For example, by connecting four secondary batteries in series, a secondary battery pack having a voltage equivalent to that of a 12V lead secondary battery can be obtained.

The present technology can also provide a lithium ion secondary battery pack configured by connecting two or more, preferably four or more (for example, four) of secondary batteries in series or in parallel as described above. For example, by connecting two or more secondary batteries in series, a secondary battery pack which can be applied to not only a 12 V system but also voltage systems such as 24 V and 48 V systems can be obtained. For example, by connecting two or more secondary batteries in parallel, the capacity of the secondary battery pack can be increased.

The lithium ion secondary battery pack of the present technology is particularly useful as a secondary battery pack for electric vehicles.

### Experimental Example 1

### Example 1

A lithium iron phosphate (LiFePO₄) (LFP) having an average grain diameter D50 of 2 μm and a specific surface area of 10 m²/g was used as a positive electrode active material. A dispersion liquid was used, which was obtained by previously crushing and dispersing the LFP in N-methylpyrrolidone (NMP) by a crushing treatment. Specifically, the crushing treatment was carried out by mixing and stirring the LFP with Eco Mill (a bead mill, manufactured by Asada Iron Works, Co., Ltd.) at 1000 rpm for 120 minutes. The content of the LFP in the dispersion liquid was 40% by weight with respect to the total amount of the dispersion liquid.

The LFP dispersion liquid, carbon black (CB) as a conductive auxiliary agent, and polyvinylidene fluoride (PVdF) as a binder were added to the NMP so that the weight ratio of LFP:CB:PVdF was set to 92:4:4, and dispersed to obtain a positive electrode slurry. Then, the positive electrode slurry was applied to both surfaces of an Al foil so that a coating amount of the positive electrode slurry on one surface (after drying) was set to 12.5 mg/cm² using a die coater, and dried. Then, the dried product was compacted at a linear pressure of about 10000 N/cm by a roll heated to 100° C. using a roll press machine, and cut into a predetermined shape to obtain a positive electrode plate.

A powder was used, which was obtained by mixing artificial graphite (average grain diameter D50: 9 μm, specific surface area: 2.9 m²/g) and flake-shaped natural graphite (average grain diameter D50: 3 μm, specific surface area: 20 m²/g) as a negative electrode active material at the weight ratio of artificial graphite:natural graphite=95:5. The negative electrode active material, styrene butadiene rubber (SBR) as a binder, and carboxymethyl cellulose (CMC) as a thickener were added into water so that the weight ratio of the negative electrode active material:SBR:CMC was set to 97:2:1, and the mixture was dispersed to obtain a negative electrode slurry. Then, the negative electrode slurry was applied to both surfaces of a Cu foil so that a coating amount of the negative electrode slurry on one surface was set to 7.5 mg/cm² using a die coater, and dried. Then, the dried product was compacted at a linear pressure of about 10000 N/cm by a roll heated to 100° C. using a roll press machine, and cut into a predetermined shape to obtain a negative electrode plate.

A plurality of positive electrode plates and negative electrode plates were alternately stacked with a separator interposed therebetween (44 positive electrode plates and 45 negative electrode plates). The positive and negative electrodes were bundled, and tab-welded, and the stacked product was then placed in an aluminum laminate cup. An electrolyte was injected into the aluminum laminate cup. The aluminum laminate cup was then subjected to vacuum temporary sealing, and charging and discharging were performed at a current value equivalent to 0.2 C. Then, a degassing treatment and fully vacuum-sealing were performed to prepare a cell having a capacity of 400 mAh. The cell was charged to 100% SOC and aged at 55° C. for 1 week to complete the cell.

As the electrolyte (liquid), 1 M of LiPF₆ was used as an electrolyte salt, and a mixture of 25 parts by volume of EC (ethylene carbonate) and 75 parts by volume of EMC (ethyl methyl carbonate) was used as a solvent. The electrolyte further contains 2% by weight of the compound 5 with respect to the total amount of the electrolyte. The compound 5 is a compound represented by the following formula, and referred to as 4,4′-bis(2,2-dioxo-1,3,2-dioxathiolane).

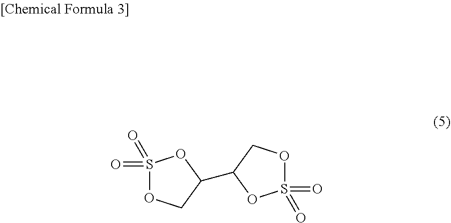 [SMILES: O=S1(=O)OCC(C2COS(=O)(=O)O2)O1]

<Method for Measuring Negative Electrode Potential (Based on Lithium Metal) when Battery is in Fully Charged State>

First, the cell was set in a fully charged state. Specifically, the cell was subjected to constant current charge at a current value (1C) which could charge and discharge a rated capacity at 25° C. in 1 hour to an upper limit voltage of 3.8 V, and a constant voltage of 3.8 V was then held until a charging current converged to 0.02 C.

Next, the cell in the fully charged state was disassembled to take out the negative electrode, and the negative electrode active material layer coated on one surface of the electrode having both surfaces each having the negative electrode active material layer was peeled off with acetone to obtain a single-sided electrode. The single-sided electrode was punched into a circle having a diameter of 11 mm with a puncher. Using this circular electrode having a diameter of 11 mm and a counter electrode Li metal, a coin cell was prepared. The battery voltage of the prepared coin cell was measured with a voltage tester, and the voltage value was taken as the potential of the fully charged negative electrode”.

### <Method for Measuring DCR at 25° C.>

First, the cell was set in a fully charged state by the same method as the above method.

Then, the fully charged cell held at 25° C. was used). When discharge was started at a current value of 13 C for 30 seconds, a value obtained by dividing a difference between a voltage before the start of the discharge and a voltage after 30 seconds by the discharged current value was taken as DCR.

### <Method for Measuring DCR at −20° C.>

First, the cell was held in a constant temperature bath set at −20° C., and the cell was set in a fully charged state in the same manner as in the method except that the cell after one hour since the temperature of the cell surface reached−20° C. was used.

Next, the fully charged cell held at −20° C. was used. When discharge was started at a current value of 13 C for 30 seconds, a value obtained by dividing a difference between a voltage before the start of the discharge and a voltage after 30 seconds by the discharged current value was taken as DCR.

AA: DCR at −20° C.≤0.25Ω (very good):

A: 0.25Ω<DCR at −20° C.≤0.31Ω (good):

B: 0.31Ω<DCR at −20° C.≤0.35Ω (no practical problem):

C: 0.35Ω<DCR at −20° C. (practical problem).

### <Method for Measuring Capacitance Density of Positive Electrode Active Material Layer>

A positive electrode active material layer coated on one surface of a positive electrode having both surfaces each having the positive electrode active material layer was peeled off with acetone to obtain a single-sided electrode. The single-sided electrode was punched into a circle having a diameter of 11 mm with a puncher. Using this circular electrode having a diameter of 11 mm and a counter electrode Li metal, a coin cell was prepared.

There were performed 5 cycles of charging the prepared coin cell at 0.5 mA to an upper limit voltage of 3.8 V, holding a constant voltage of 3.8 V until the current converged to 0.01 mA, and discharging coin cell at a constant current of 0.5 mA to a lower limit voltage of 2.5 V. A value obtained by standardizing a discharge capacity in the 5th cycle with the area of the circular electrode having a diameter of 11 mm was taken as one-sided “capacitance density”.

A pore curvature was measured as a pore curvature degree ξ with a measuring apparatus “Autopore IV 9500” (manufactured by Shimadzu Corporation) based on a mercury porosimeter.

As the physical property values of mercury used during measurement, a contact angle of 130°, a surface tension of 485.0 dyn/cm, and a density of 13.5335 g/mL were used.

In each of the positive electrode active material layer and the negative electrode active material layer, measurements were performed at optional 100 points, and the average value thereof was used.

The average grain diameter D50 was measured by a laser diffraction particle size distribution analyzer (LA960, manufactured by Horiba, Ltd.). In the present specification, the volume-based cumulative 50% diameter (D50) measured by this analyzer is expressed as an average grain diameter.

The specific surface area (SSA) was measured by a specific surface area measuring apparatus (Macsorb, manufactured by Mountech Co., Ltd.). In the present specification, the specific surface area (m²/g) measured by this measuring apparatus is expressed as SSA.

### Examples 2 to 15 and Comparative Examples 1 to 13

A positive electrode was prepared by the same method as that in Example 1 except that a mixing time in a crushing treatment of LFP and a pressure by a roll press machine were changed to adjust a curvature and a capacitance density to predetermined values shown in Table 1 when the positive electrode was prepared.

A negative electrode was prepared by the same method as that in Example 1 except that a pressure by a roll press machine was changed to adjust a curvature and a fully charged negative electrode potential to predetermined values described in Table 1.

A cell was prepared and evaluated (measured) by the same method as that in Example 1 except that the positive electrode and the negative electrode described above were used.

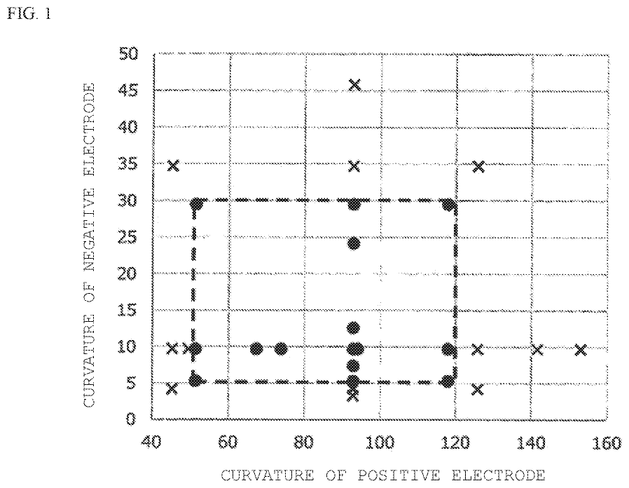

FIG. 1 shows the relationship between the pore curvatures of the positive electrode active material layer and the negative electrode active material layer in the cell produced in Experimental Example 1 and the evaluation results of DCR at −20° C.

In FIG. 1, black circles indicate Examples and x marks indicate Comparative Examples.

TABLE 1

| | | Capacitance | | | | |
|---|---|---|---|---|---|---|
| | | density of | | Potential | | |
| | Curvature | positive | Curvature | of negative | 25° C. | −20° C. |
| | of positive | electrode | of negative | electrode⁽¹⁾ | DCR | DCR |
| | electrode | [mAh/cm2] | electrode | [mV] | [Ω] | [Ω] |
| Example 1 | 92.9 | 1.7 | 5.3 | 121 | 0.08 | 0.32B |
| Example 2 | 92.9 | 1.7 | 7.4 | 121 | 0.08 | 0.24AA |
| Example 3 | 92.9 | 1.7 | 9.7 | 121 | 0.08 | 0.23AA |
| Example 4 | 92.9 | 1.7 | 12.8 | 121 | 0.08 | 0.25AA |
| Example 5 | 92.9 | 1.7 | 24.2 | 121 | 0.08 | 0.29A |
| Example 6 | 92.9 | 1.7 | 29.5 | 121 | 0.08 | 0.34B |
| Example 7 | 51.4 | 1.7 | 9.7 | 121 | 0.08 | 0.34B |
| Example 8 | 67.4 | 1.7 | 9.7 | 121 | 0.08 | 0.29A |
| Example 9 | 73.9 | 1.7 | 9.7 | 121 | 0.08 | 0.3A |
| Example 10 | 94.1 | 1.7 | 9.7 | 121 | 0.08 | 0.31A |
| Example 11 | 118 | 1.7 | 9.7 | 121 | 0.08 | 0.33B |
| Example 12 | 51.4 | 1.7 | 5.3 | 121 | 0.08 | 0.28A |
| Example 13 | 51.4 | 1.7 | 29.5 | 121 | 0.08 | 0.3A |
| Example 14 | 118 | 1.7 | 5.3 | 121 | 0.08 | 0.29A |
| Example 15 | 118 | 1.7 | 29.5 | 121 | 0.08 | 0.35B |
| Comparative | 92.9 | 1.7 | 3.3 | 121 | 0.09 | 0.41C |
| Example 1 | | | | | | |
| Comparative | 92.9 | 1.7 | 4.2 | 121 | 0.09 | 0.36C |
| Example 2 | | | | | | |
| Comparative | 92.9 | 1.7 | 34.2 | 121 | 0.09 | 0.38C |
| Example 3 | | | | | | |
| Comparative | 92.9 | 1.7 | 45.8 | 121 | 0.09 | 0.47C |
| Example 4 | | | | | | |
| Comparative | 45.3 | 1.7 | 9.7 | 121 | 0.09 | 0.45C |
| Example 5 | | | | | | |
| Comparative | 49.6 | 1.7 | 9.7 | 121 | 0.09 | 0.4C |
| Example 6 | | | | | | |
| Comparative | 125.9 | 1.7 | 9.7 | 121 | 0.09 | 0.37C |
| Example 7 | | | | | | |
| Comparative | 141.6 | 1.7 | 9.7 | 121 | 0.09 | 0.41C |
| Example 8 | | | | | | |
| Comparative | 153 | 1.7 | 9.7 | 121 | 0.09 | 0.43C |
| Example 9 | | | | | | |
| Comparative | 45.3 | 1.7 | 4.2 | 121 | 0.09 | 0.45C |
| Example 10 | | | | | | |
| Comparative | 45.3 | 1.7 | 34.7 | 121 | 0.09 | 0.47C |
| Example 11 | | | | | | |
| Comparative | 125.9 | 1.7 | 4.2 | 121 | 0.09 | 0.42C |
| Example 12 | | | | | | |
| Comparative | 125.9 | 1.7 | 34.7 | 121 | 0.09 | 0.46C |
| Example 13 | | | | | | |

⁽¹⁾Potential of negative electrode during full charge

### Experimental Example 2

### Examples 16 to 22

A positive electrode was prepared by the same method as that in Example 1 except that a mixing time in a crushing treatment of LFP, an amount of a slurry applied, and a pressure by a roll press machine were changed to adjust a curvature and a capacitance density to predetermined values described in Table 2 when the positive electrode was prepared.

A negative electrode was prepared by the same method as that in Example 1 except that an amount of a slurry applied and a pressure by a roll press machine were changed to adjust a curvature and a fully charged negative electrode potential to predetermined values described in Table 2 when the negative electrode was prepared.

A cell was prepared and evaluated (measured) by the same method as that in Example 1 except that the positive electrode and the negative electrode described above were used.

TABLE 2

| | | Capacitance | | | |
|---|---|---|---|---|---|
| | Curvature | density | Curvature | Potential | |
| | of | of positive | of | of negative | −20° |
| | positive | electrode | negative | electrode ⁽¹⁾ | CDCR |
| | electrode | [mAh/cm2] | electrode | [mV] | [Ω] |
| Example | 92.9 | 1.7 | 9.7 | 34 | 0.29A |
| 16 | | | | | |
| Example | 92.9 | 1.7 | 9.7 | 93 | 0.27A |
| 17 | | | | | |
| Example | 92.9 | 1.7 | 9.7 | 114 | 0.23AA |
| 18 | | | | | |
| Example | 92.9 | 1.7 | 9.7 | 121 | 0.23AA |
| 19 | | | | | |
| Example | 92.9 | 1.7 | 9.7 | 126 | 0.23AA |
| 20 | | | | | |
| Example | 92.9 | 1.7 | 9.7 | 190 | 0.25AA |
| 21 | | | | | |
| Example | 92.9 | 1.7 | 9.7 | 220 | 0.27A |
| 22 | | | | | |

⁽¹⁾ Potential of negative electrode during full charge

### Experimental Example 3

### Examples 23 to 29

Cells were prepared and evaluated (measured) by the same method as that in Example 3 except that the concentration of a compound 5 in an electrolyte was adjusted to predetermined values shown in Table 3.

### <Method for Measuring DCR at −20° C. Before Cycle>

DCR at −20° C. before a cycle means DCR at −20° C.

<Method for Measuring DCR at −20° C. after Cycle>

DCR was obtained by the same method as the method for measuring DCR at −20° C. except that a cell in which 1000 charge/discharge cycles were repeated by the following method was used.

Charge/Discharge Cycle

1000 cycles of charging the cell to 3.625 V at 5 C at 55° C., maintaining the voltage of 3.625 V until the current reached 0.02 C, and discharging the cell to 2.5 V at 5 C were repeated.

The DCR maintenance rate is a value expressed as “(R2/R1)×100 (%)” when DCR at −20° C. before a cycle is “R1” and DCR at −20° C. after a cycle is “R2”.

AA: 115% or less (best):

B: More than 115% and 125% or less (very good):

C: More than 125% and 135% or less (good):

D: More than 135% and 145% or less (no practical problem):

E: More than 145% (practical problem).

TABLE 3

| | | | Capacitance | | | | before | after | |
|---|---|---|---|---|---|---|---|---|---|
| | | | density | | Potential | | cycle | cycle | |
| | Concentration | Curvature | of positive | Curvature | of negative | 25° C. | −20° C. | −20 C. | DCR |
| | of additive | of positive | electrode | of negative | electrode ⁽¹⁾ | DCR | DCR | DCR | maintenance |
| | [wt %] | electrode | [mAh/cm2] | electrode | [mV] | [Ω] | [Ω] | [Ω] | rate |
| Example | 0 | 92.9 | 1.7 | 9.7 | 121 | 0.08 | 0.26A | 0.49 | 188% C |
| 23 | | | | | | | | | |
| Example | 0.5 | 92.9 | 1.7 | 9.7 | 121 | 0.08 | 0.25AA | 0.34 | 136% B |
| 24 | | | | | | | | | |
| Example | 1 | 92.9 | 1.7 | 9.7 | 121 | 0.08 | 0.24AA | 0.31 | 129% A |
| 25 | | | | | | | | | |
| Example | 1.5 | 92.9 | 1.7 | 9.7 | 121 | 0.08 | 0.23AA | 0.28 | 122% AA |
| 26 | | | | | | | | | |
| Example | 2 | 92.9 | 1.7 | 9.7 | 121 | 0.08 | 0.23AA | 0.26 | 112% AAA |
| 27 | | | | | | | | | |
| Example | 2.5 | 92.9 | 1.7 | 9.7 | 121 | 0.08 | 0.23AA | 0.3 | 130% A |
| 28 | | | | | | | | | |
| Example | 3 | 92.9 | 1.7 | 9.7 | 121 | 0.08 | 0.29A | 0.38 | 131% A |
| 29 | | | | | | | | | |

⁽¹⁾ Potential of negative electrode during full charge

The secondary battery of the present technology can be used in various fields in which electricity storage is assumed. Although the followings are merely examples, the secondary battery of the present technology can be used in electricity, information and communication fields where mobile devices and the like are used (for example, mobile device fields, such as mobile phones, smart phones, smart watches, laptop computers, digital cameras, activity meters, arm computers, and electronic papers), domestic and small industrial applications (for example, the fields such as electric tools, golf carts, domestic robots, caregiving robots, and industrial robots), large industrial applications (for example, the fields such as forklifts, elevators, and harbor cranes), transportation system fields (for example, the fields such as hybrid vehicles, electric vehicles, buses, trains, electric assisted bicycles, and two-wheeled electric vehicles), electric power system applications (for example, the fields such as various power generation systems, load conditioners, smart grids, and home-installation type power storage systems), medical care applications (the medical care instrument fields such as earphone acoustic aids), medicinal applications (the fields such as dosing management systems), IoT fields, and space and deep sea applications (for example, the fields such as spacecraft and research submarines).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A lithium ion secondary batter comprising:
a positive electrode;
a negative electrode;
a separator disposed between the positive electrode and the negative electrode; and
a non-aqueous electrolyte,
wherein
the positive electrode includes a positive electrode active material layer including a lithium iron phosphate;
the positive electrode active material layer has a pore curvature from 50 to 120 as measured by a mercury porosimeter;
the negative electrode includes a negative electrode active material layer including graphite; and
the negative electrode active material layer has a pore curvature from 5 to 30 as measured by the mercury porosimeter.

2. The lithium ion secondary battery according to claim 1, wherein the positive electrode active material layer has a capacitance density from 0.25 mAh/cm² to 3.0 mAh/cm² for a surface of the positive electrode.

3. The lithium ion secondary battery according to claim 1, wherein a potential of the negative electrode when the lithium ion secondary battery is in a fully charged state is from 100 mV to 200 mV based on lithium metal.

4. The lithium ion secondary battery according to claim 1, wherein:
the negative electrode active material layer further includes a binder including styrene-butadiene rubber, acrylic resin, or a derivative thereof, and a thickener including carboxymethyl cellulose;
a content of the binder is from 0.5% by weight to 2.5% by weight with respect to a total amount of the negative electrode active material layer; and
a content of the thickener is from 0.5% by weight to 1.5% by weight with respect to the total amount of the negative electrode active material layer.

5. The lithium ion secondary battery according to claim 1, wherein:
the non-aqueous electrolyte includes a cyclic sulfate ester compound; and
a content of the cyclic sulfate ester compound is from 0.2% by weight to 5.0% by weight with respect to a total amount of the non-aqueous electrolyte.

6. The lithium ion secondary battery according to claim 5, wherein the cyclic sulfate ester compound includes an organic compound having a molecular weight of 124 to 800, and including one or two dioxathiolane skeletons in a molecule.

7. The lithium ion secondary battery according to claim 1, wherein the lithium ion secondary battery has a stacked structure.

8. The lithium ion secondary battery according to claim 1, wherein the non-aqueous electrolyte includes a liquid.

9. The lithium ion secondary battery according to claim 1,
wherein
the positive electrode active material layer has a pore curvature from 55 to 110; and
the negative electrode active material layer has a pore curvature from 6 to 28.

10. A lithium ion secondary battery pack configured by connecting two or more lithium ion secondary batteries according to claim 1 in series.

11. The lithium ion secondary battery pack according to claim 10, wherein the lithium ion secondary battery pack include a secondary battery pack for electric vehicles.

12. A lithium ion secondary battery pack configured by connecting two or more lithium ion secondary batteries according to claim 1 in parallel.

13. The lithium ion secondary battery pack according to claim 12, wherein the lithium ion secondary battery pack include a secondary battery pack for electric vehicles.
